(19) United States
(12) Patent Application Publication
(10) Pub. No.: US 2026/0353201 A1
(43) Pub. Date: Nov. 5, 2026

(54) SYSTEMS, METHODS, AND DEVICES FOR ENHANCED AIR-TO-GROUND (ATG) HANDOVER

(71) Applicant: Apple Inc., Cupertino, CA (US)

(72) Inventors: Qiming Li, Beijing (CN); Jie Cui, San Jose, CA (US); Yang Tang, San Jose, CA (US); Manasa Raghavan, Sunnyvale, CA (US); Haitong Sun, Saratoga, CA (US); Xiang Chen, Palo Alto, CA (US); Yuexia Song, Beijing (CN); Rolando Bettancourt Ortega, Munich (DE); Dawei Zhang, Saratoga, CA (US); Hong He, San Jose, CA (US)

(21) Appl. No.: 19/111,829

(22) PCT Filed: Sep. 30, 2022
(86) PCT No.: PCT/CN2022/123265

§ 371 Date: Mar. 14, 2025

(51) Int. Cl. H04W 36/00; H04W 4/42; H04W 36/30; H04W 36/32

(52) U.S. Cl. CPC H04W 36/0058; H04W 4/42; H04W 36/0072; H04W 36/00837; H04W 36/304; H04W 36/326

(57) ABSTRACT

Techniques for enabling enhanced air-to-ground (ATG) handover procedures for high-velocity user equipment (UEs), such as an airplane, jet, drone, etc. A UE or a serving base station may make a handover decision based on distances between the UE and the serving base stations and a target base station. In some scenarios, the UE or serving base station may make a handover decision based on a UE flight path, including changes in the UE flight path, or the UE reaching a flight path checkpoint (e.g., a location identified along the flightpath). In some scenarios, the serving base station may make a handover decision based on a distance report from the UE, or the UE may make the handover decision based on a signal strength and/or quality from a target base station. Additional details and examples of these and many other features and techniques are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) to maintain service while moving throughout a network.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview according to one or more implementations described herein.

FIG. 2 is a diagram of an example network according to one or more implementations described herein.

FIG. 3 is a diagram of an example process for a serving base station making a handover decision based on user equipment (UE) distances according to one or more implementations described herein.

FIG. 4 is a diagram of an example process for a serving base station making a handover decision based on a UE flight path according to one or more implementations described herein.

FIG. 5 is a diagram of an example process for a serving base station making a handover decision based on a distance report from a UE according to one or more implementations described herein.

FIG. 6 is a diagram of an example process for a serving base station making a handover decision based on a signal strength and quality report from a UE according to one or more implementations described herein.

FIG. 7 is a diagram of an example process for a UE making a handover decision based on UE distances according to one or more implementations described herein.

FIG. 8 is a diagram of an example process for a UE making a handover decision based on a UE flight path according to one or more implementations described herein.

FIG. 9 is a diagram of an example process for a serving base station making a handover decision based on a UE reaching a flight path checkpoint according to one or more implementations described herein.

FIG. 10 is a diagram of an example of components of a device according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device. A UE may also include UE-capable objects and devices. A UE-capable device may include a car, truck, or train with suitable components for operating as a UE. Currently available technologies may include adequate solutions for enabling lower velocity UEs to maintain network connections as they move from one cell to another. However, currently available technologies fail to provide adequate solutions for high-velocity UEs.

For example, UEs may include UE-capable machines and devices capable of very high-velocity travel (e.g., around 1200 kilometers per hour), such as drones, helicopters, airplanes, jets, rockets, etc. Such devices may include UE components (e.g., antennas, processors, memory, storage, software, data, power source, etc.) for communicating with terrestrial or ground-based base stations having extremely large cell coverage ranges (e.g., up to 300 kilometers). However, currently available technologies fail to provide solutions for enabling smooth or seamless handovers as a high-velocity UE (also referred to herein as “UE”) travel from one cellular coverage area to another.

The techniques described herein provide solutions for enabling enhanced air-to-ground (ATG) handover procedures for high-velocity UEs.

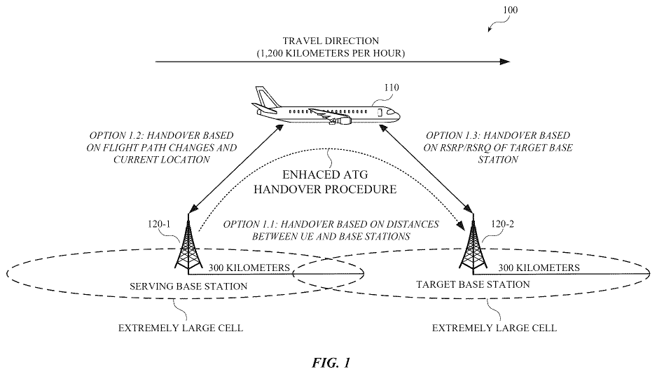

FIG. 1 is an example overview 100 according to one or more implementations described herein. As shown, example overview 100 may include UE 110, serving base station 120-1, and target base station 120-2. UE 110 may be an airplane or another type of UE-capable device or object capable of traveling at a very high velocity (e.g., 1,200 kilometers per hour).

Base stations 120-1 and 120-2 may be long-range base stations capable of projecting a cell with a large radial signal distance (e.g., 300 kilometers). As described below, the techniques described herein include solutions for a handover decision to be made by UE 110 or base station 120-1, which may be based on one or more types of triggers, conditions, reports, or information.

For instance, in some implementations, UE 110 or serving base station 120-1 may make a handover decision based on distances between UE 110 and base stations 120-1 and 120-2 (at 1.1). In some scenarios, UE 110 or serving base station 120-1 may make a handover decision based on a UE flight path, including changes in a UE flight path and a current position of UE 1120 or UE 110 reaching a flight path checkpoint (e.g., a location identified along the flightpath) (at 1.2). In some implementations, UE 110 may make the handover decision based on one or more signals (e.g., a reference signal received power (RSRP), a reference signal received quality (RSRQ), etc., and corresponding signal thresholds (at 1.3). In some implementations, a handover decision may be based one or more of the foregoing conditions (e.g., a distance between UE 110 and base stations 120-1 and 120-2, a UE flight path and location, and/or a received signal from base stations 120-1 or 120-2). The techniques described herein are not limited to UEs 110 of a particular type or travel velocity, nor are they limited to base stations of a certain cell size or coverage area. Additional details and examples of these and other implementations are described below with reference to the Figures.

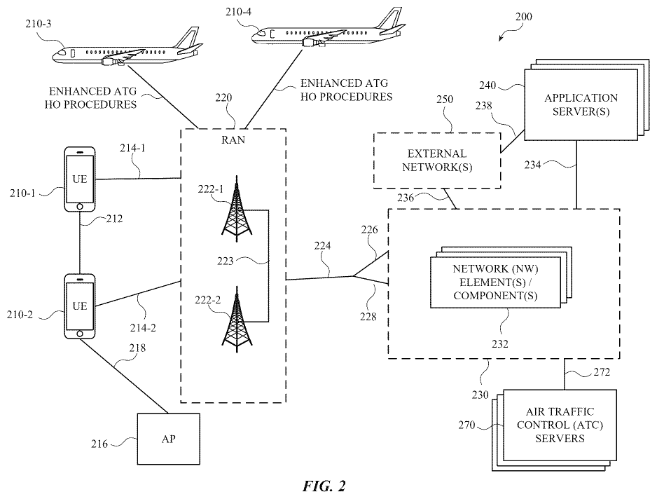

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210-1 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-PATENT DC) architectures, or the like. In some implementations, a base station (as described herein) may be an example of network node 222.

UEs 210-3 and 210-4 may include UE-capable vehicles or devices capable of high-velocity travel (e.g., around 1200 kilometers per hour). In some implementations, UEs 210-3 and 210-4 may include drones, helicopters, airplanes, jets, rockets, or other vehicles or devices capable of flight. In other implementations, UEs 210-3 and 210-4 may also, or alternatively, include high-velocity vehicles or devices that may travel over land, over water, or under water.

Such devices may include UE components (e.g., antennas, processors, memory, storage, software, data, power sources, etc.) suitable for communicating with terrestrial or ground-based RAN nodes 222 (also referred to herein as “base station 222” or “base stations 222”) having extremely large cell coverage ranges (e.g., up to 300 kilometers).

As described herein, UE 210 or serving base station 222 may make a handover decision based on distances between UE 210 and serving base stations 222 and target base station 222. In some scenarios, UE 210 or serving base station 222 may make a handover decision based on a UE flight path, including changes in a UE flight path or UE 210 reaching a flight path checkpoint (e.g., a location identified along the flightpath). In some scenarios, serving base station 222 may make a handover decision based on a distance report from UE 210 or UE 110 may make the handover decision based on a signal strength and/or quality from target base station 222. Additional details and examples of these and other implementations are described below with reference to the Figures.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, 6G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHZ unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 210 to undergo a handover. In LAA, eLAA, and feLAA, some or all the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different physical uplink shared channel (PUSCH) starting positions within a same subframe. To operate in the unlicensed spectrum, UEs 210 and the RAN nodes 222 may also operate using stand-alone unlicensed operation where the UE may be configured with a PCell, in addition to any SCells, in unlicensed spectrum.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. In some implementations, such as a standalone (SA) implementation, interface 223 may be an Xn interface. In some implementations, such as non-standalone (NSA) implementations, interface 223 may represent an X2 interface and an XN interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2control plane interface (X2-C). The X2-U may provide flow control mechanisms for user data packets transferred over the X2 interface and may be used to communicate information about the delivery of user data between eNBs or gNBs.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

Air traffic control (ATC) servers 270 may include one or more servers, server devices, or network elements (e.g., VNFs) configured to send, receive, process, and/or store information. ATC servers 270 may communicate with CN via connection or interface 272, which may include IP network interfaces. As described herein, ATC servers 270 may be operated by one or more air traffic control departments, organizations, or entities. ATC servers 270 may include information about airplanes, jets, helicopters, drones, and/or other types of ariel transportation devices, including departure locations and times, flight patterns, current locations, updated flight patterns, arrival locations and times, altitudes, velocities, weather conditions, and more. ATC servers 270 may receive information about UEs 222-3 and 222-4 from base stations 222, air traffic control towers or an air traffic control network (not shown), etc., about changes in a current location and/or current flight path of UEs 222-3 and 222-4. ATC servers 270 may store such information and provide such information to base stations 222 (e.g., upon request, in accordance with an update schedule, etc.).

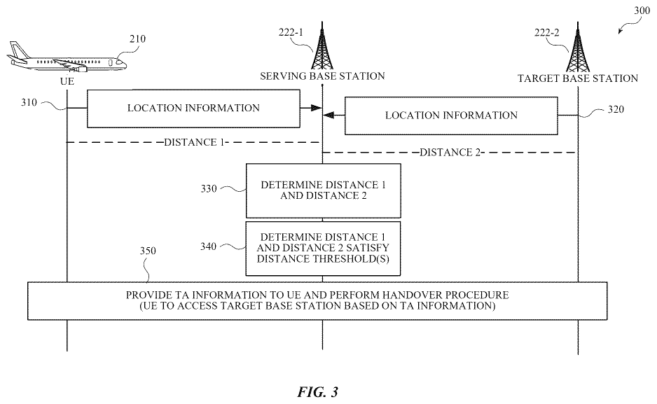

FIGS. 3-9 are diagrams of example processes 300-900 according to one or more implementations described herein. Processes 300-900 may be implemented by UE 210, serving base station 222-1, and target base station 222-2. In some implementations, UE 210 and base stations 222-1 and 222-2 may be configured to implement one or more of processes 300-900 depending on, for example, a condition, trigger, scenario, or configuration of one or more of UE 210 and base stations 222-1 and 222-2. Additionally, or alternatively, some or all of processes 300 may be performed by one or more other systems or devices, including one or more of the devices of FIG. 2. Furthermore, any of processes 300-900 may include one or more fewer, additional, differently ordered and/or arranged operations than those shown in any of FIGS. 3-9, including other processes and/or operations discussed herein. For example, any of processes 300-900 may include operations preceding, performed in parallel with, and/or following one or more of the depicted operations. Some or all the operations of any of processes 300-900 may be performed independently, successively, simultaneously, etc., of one or more of the other operations of another of processes 300-900. As such, the techniques described herein are not limited to a number, sequence, arrangement, timing, etc., of the operations or processes depicted in any of FIGS. 3-9.

FIG. 3 is a diagram of an example process 300 for a serving base station making a handover decision based on UE distances according to one or more implementations described herein. As shown, process 300 may include serving base station 222-1 receiving location information from UE 210 (at 310). In some implementations, UE 210 may report location information (e.g., its current location) to base station 222-1. In some implementations, base station 222-1 may use a DL channel to send UE 210 a request for location information, and UE 210 may provide the information in response to the request.

In some implementations, UE 210 may provide or report its location, with a time stamp and movement information (e.g., a speed and direction). In such implementations, base station 222-1 may use such information to determine or predict a current location of UE 210 based on the location information, timestamp or transmission time, movement information, and a current or reception time. In some implementations, UE 210 may also provide a validity timer, such that base station 222 may use the location information, timestamp, and movement information, for the duration of the timer, to accurately or reliably determine or predict the location of UE 210.

Base station 222-1 may also receive location information for one or more base stations 222 in the area, such as target base station 222-2 (at 320). In some implementations, base station 222-1 may use a backhaul or Xn interface to send a request for location information to base station 222-2, and base station 222-2 may respond with the location information via the interface. In some implementations, location information may be requested and received using higher layer node, such as an access and mobility function (AMF) or a location management function (LMF).

Process 300 may include serving base station 222-1 determining distances 1 and 2 based on the location information from UE 210 and base station 222-1 (at 330). A distance between UE 210 and serving base station 222-1 may be distance 1, and a distance between base stations 222-1 and 222-2 may be distance 2. Serving base station 222-1 may determine distances 1 and 2 based on a location of base station 222-1 and the location information received from UE 210 and base station 222-2.

Process 300 may also include base station 222-1 determining that distances 1 and distance 2 satisfy one or more distance threshold (at 340). In some implementations, distances 1 and 2 may satisfy the distance thresholds when distance 1 is greater than a first threshold distance and distance 2 is less than a threshold distance. Additionally, or alternatively, distances 1 and 2 may satisfy the distance thresholds when distance 1 exceeds distance 2 by at least a preselected or configured different (e.g., a preconfigured number (X) of meters).

Process 300 may include serving base station 222-1 providing timing advance (TA) information to UE 210 and performing a handover procedure (block 350). The TA information may be to enable UE 210 to communicate with target base station 222-2. In some implementations, serving base station 222-1 may provide UE 210 with location information of target base station 222-2, and UE 210 may derive the TA based on a current location of UE 210 and the location information of target base station 222-2.

The handover procedure may include an inter-frequency handover procedure or an intra-frequency handover procedure. Additionally, the handover procedure may include base station 222-1 sending a handover request to target base station 222-2, target base station 222-2 performing admission control, and base station 222-1 receiving a handover request acknowledgement from base station 222-2. The handover procedure may also include serving base station 222-1 sending UE 210 a handover trigger message and detaching from the serving base station 222-1, discovering, synchronizing, and connecting to target base station 222-2, etc. In some implementations, base station 222-1 may provide TA information to UE 210 regarding target base station 222-2. UE 210 may use the TA to transmit a random access channel (RACH) message to target base station 222-2. The RACH Tx timing may be based on a DL reception time (from target base station 222-2) minus the TA. UE 210 may use the TA information to contact and begin communicating with target base station 222-2 as part of the handover procedure. Additional and/or alternative operations (e.g., messages, types of information, etc.) may be involved in performing the handover procedure.

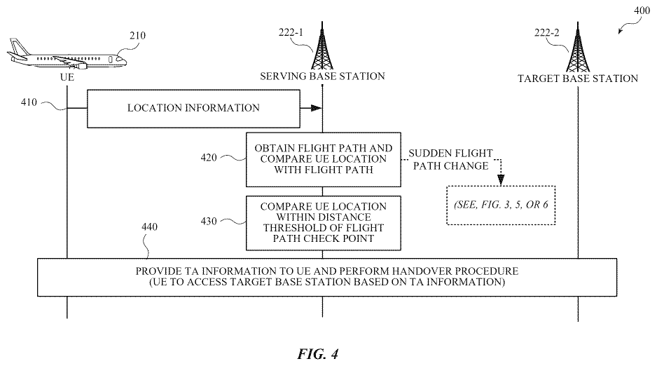

FIG. 4 is a diagram of an example process 400 for serving base station 222-1 making a handover decision based on a UE flight path according to one or more implementations described herein. As shown, process 400 may include serving base station 222-1 receiving location information from UE 210 (at 410). In some implementations, UE 210 may report location information (e.g., its current location) to base station 222-1. In some implementations, base station 222-1 may use a DL channel to send UE 210 a request for location information, and UE 210 may provide the information in response to the request.

In some implementations, UE 210 may provide or report its location, with a time stamp and movement information (e.g., a speed and direction). In such implementations, base station 222-1 may use such information to determine or predict a current location of UE 210 based on the location information, timestamp or transmission time, movement information, and a current or reception time. In some implementations, UE 210 may also provide a validity timer, such that base station 222 may use the location information, timestamp, and movement information, for the duration of the timer, to accurately or reliably determine or predict the location of UE 210.

Process 400 may include serving base station 222-1 obtaining a flight plan for UE 210 and compare a location of UE 210 with the flight plan (block 420). For example, base station 222-2 may obtain a flight path for UE 210. In some implementations, base station 222-2 may obtain the flight path by sending a request to UE 210 for the flight path and receiving the flight path in response thereto. In some implementations, base station 222-1 may also, or alternatively, obtain the flight path by contacting another device, such as ATC servers 270 (see, FIG. 2). In some implementations, UE 210 may proactively provide base station 222-1 with a new or updated flight path upon diverting from or changing a previous flight path. Additionally, or alternatively, UE 210 may proactively update ATC servers 270, and ATC servers 270 may proactively update base station 222-1.

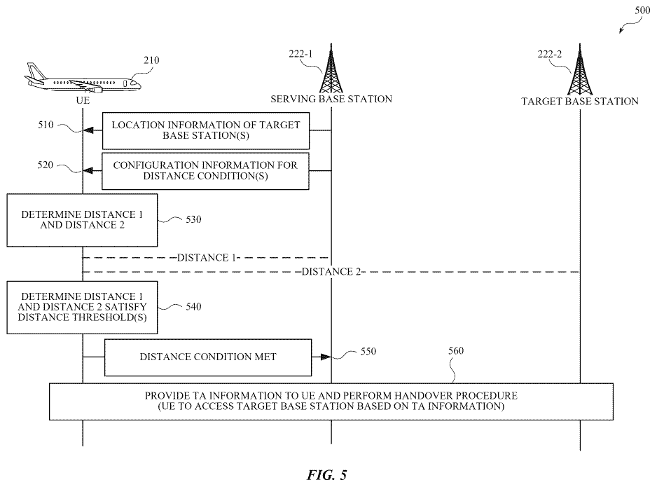

Base station 222-2 may determine a current location of UE 210 and compare the current location to the flight path. Based on the comparison, base station 222-2 may determine whether there has been a sudden change (e.g., unplanned) in flight pant for UE 210. When a sudden change to the flight path (e.g., UE 210 is not traveling consistent with the most recent flight path obtained by base station 222-1), process 400 may proceed to implement one or more of examples 300, 500, or 600 of FIGS. 3, 5, or 6 to detect and trigger a handover procedure for UE 210. When the flight plan has not suddenly changed, process 400 may include base station 222-2 comparing a current location of UE with a distance threshold relative to a flight path check point (at 430).

The flight path may include one or more check points, and each check point may correspond to a handover procedure to be performed when UE 210 is within a threshold distance of the check point. As such, base station 222-1 may determine a distance between a current location of UE 210 and a check point of the flight path and compare the determined distance to a threshold distance. When the determined distance is greater than the threshold distance, process 400 may proceed by base station 222-1 continuing to monitor UE 210 for changes in the flight plan and changes in a distance between the UE 210 and the check point.

When the determined distance is less than the threshold distance, process 400 may proceed by base station 222-1 providing TA information to UE 210 and performing a handover procedure (block 440). The TA information may be to enable UE 210 to communicate with target base station 222-2. In some implementations, serving base station 222-1 may provide UE 210 with location information of target base station 222-2, and UE 210 may derive the TA based on a current location of UE 210 and the location information of target base station 222-2.

The handover procedure may include an inter-frequency handover procedure or an intra-frequency handover procedure. Additionally, the handover procedure may include base station 222-1 sending a handover request to target base station 222-2, target base station 222-2 performing admission control, and base station 222-1 receiving a handover request acknowledgement from base station 222-2. The handover procedure may also include serving base station 222-1 sending UE 210 a handover trigger message and detaching from the serving base station 222-1, discovering, synchronizing, and connecting to target base station 222-2, etc. In some implementations, base station 222-1 may provide TA information to UE 210 regarding target base station 222-2. UE 210 may use the TA to transmit a random access channel (RACH) message to target base station 222-2. The RACH Tx timing may be based on a DL reception time (from target base station 222-2) minus the TA. UE 210 may use the TA information to contact and begin communicating with target base station 222-2 as part of the handover procedure. Additional and/or alternative operations (e.g., messages, types of information, etc.) may be involved in performing the handover procedure.

FIG. 5 is a diagram of an example process 500 for a serving base station making a handover decision based on a distance report from a UE according to one or more implementations described herein. As shown, process 500 may include serving base station 222-1 providing UE 210 with location information of one or more target base stations 222-2 (at 510). Base station 222-1 may have this information stored locally and/or may obtain it from other base stations 222 as describe above. The location information may be a preconfigured list of base stations 222 or a list of base stations 222 that are identified based on a current position, direction, and speed of UE 210, a travel path, and/or one or more factors.

Process 500 may include base station 222-1 providing UE 210 with configuration information about distances and/or conditions related to handover procedures (at 520). The configuration information may define a first distance (distance 1) as a distance between serving base station 222-1 and UE 210. The configuration information may define a second distance (distance 2) as a distance between UE 210 and one or more target base stations 222-2. This may include target base stations 222-2 identified by the location information of target base stations provided to UE 210 previously. The configuration information about distances and/or conditions may include a first threshold (threshold 1) for distance 1, a second threshold (threshold 2), and a third threshold (threshold 3) for a difference between distance 1 and distance 2.

Process 500 may include UE 210 determining or calculating distance 1 and distance 2 (at 530). Process 500 may also include UE 210 comparing distances 1 and 2 to thresholds 1 and 2, respectively. When UE 210 determines that distances 1 and 2 do not satisfy thresholds 1 and 2, UE 210 may return to determining or calculating distances 1 and distance 2 (at 530) and comparing them to thresholds 1 and 2, respectively. When UE 210 determines that distances 1 and 2 satisfy thresholds 1 and 2, respectively (at 540), process 500 may proceed with UE 210 reporting or communicating to base station 222-1 that distance condition has been met (at 550). Additionally, or alternatively, UE 210 may determine that the distance condition has been met when distance 1 is above threshold 1 and distance 2 is blow threshold 2. Additionally, or alternatively, UE 210 may determine that the distance condition has been met when distance 1 minus distance 2 is greater than threshold 3.

Process 500 may include base station 222-1 responding by base station 222-1 providing TA information to UE 210 and performing a handover procedure (block 560). The TA information may be to enable UE 210 to communicate with target base station 222-2. In some implementations, serving base station 222-1 may provide UE 210 with location information of target base station 222-2, and UE 210 may derive the TA based on a current location of UE 210 and the location information of target base station 222-2.

The handover procedure may include an inter-frequency handover procedure or an intra-frequency handover procedure. Additionally, the handover procedure may include base station 222-1 sending a handover request to target base station 222-2, target base station 222-2 performing admission control, and base station 222-1 receiving a handover request acknowledgement from base station 222-2. The handover procedure may also include serving base station 222-1 sending UE 210 a handover trigger message and detaching from the serving base station 222-1, discovering, synchronizing, and connecting to target base station 222-2, etc. In some implementations, base station 222-1 may provide TA information to UE 210 regarding target base station 222-2. UE 210 may use the TA to transmit a random access channel (RACH) message to target base station 222-2. The RACH Tx timing may be based on a DL reception time (from target base station 222-2) minus the TA. UE 210 may use the TA information to contact and begin communicating with target base station 222-2 as part of the handover procedure. Additional and/or alternative operations (e.g., messages, types of information, etc.) may be involved in performing the handover procedure.

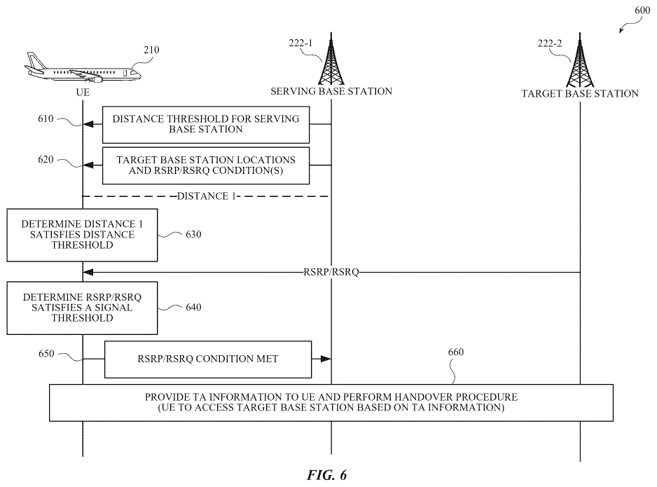

FIG. 6 is a diagram of an example process 600 for a serving base station making a handover decision based on a signal strength and quality report from a UE according to one or more implementations described herein. As shown, process 600 may include serving base station 222-1 providing UE 210 with a distance threshold for serving base station 222-1 (at 610). The distance threshold may pertain to a distance (distance 1) between UE 210 and serving base station 222-1. In some implementations, the distance threshold may be preconfigured or preselected (e.g., stored in a local memory as a configuration setting). In some implementations, base station 222-1 may determine the distance threshold based on location, velocity, travel pattern, trajectory, device type, etc., of UE 210.

Process 600 may also include serving base station 222-1 providing location information for one or more target base stations 222-2 and RSRP and/or RSRQ conditions (at 620). Whether an RSRP and/or RSRQ condition is implemented may depend on a network configuration. For example, when the network relies on HO signal strength, then an RSRP condition may be used. By contrast, when the network relies on HO signal quality (quality being different from pure strength because an interference level may also be included in a quality indicator) then an RSRQ condition may be used.

Process 600 may include UE 210 determining that distance 1 satisfies the distance threshold (at 630). For example, UE 210 may determine a distance between UE 210 and serving base station 222-1 and may compare the determined distance to the threshold distance received from base station 222-1. UE 210 may determine the distance (distance 1) based on a location of UE 210 and a location of serving base station 222-1, signal delays (e.g., a delay between a Tx time and a Rx time) between signals from UE 210 and base station 222-1, etc.

Process 600 may include determining that an RSRP and/or RSRQ satisfies a signal threshold (at 640). For example, UE 210 may receive, monitor, and/or measure a RSRP and/or an RSRQ value based on signals from serving base station 222-1 and/or target base station 222-2. UE 210 may be preconfigured with (e.g., have stored in a local memory) and/or have received from serving base station 222-1 a signal threshold relating to RSRP signals, RSRQ signals, and/or a combination of RSRP and RSRQ signals from serving base station 222-1 and/or target base station 222-2. UE 210 may compare the RSRP and/or RSRQ signal values or measurements to the signal threshold(s) to determine whether the threshold(s) are satisfied. In some implementations, the signaling conditions may be satisfied when an RSRP and/or RSRQ signal of target base station 222-2 satisfies a corresponding threshold(s). In some implementations, the signaling conditions may be satisfied when an RSRP and/or RSRQ signal of serving base station 222-1 and/or target base station 222-2 satisfy corresponding thresholds-for instance when an RSRP and/or RSRQ signal of serving base station 222-1 is below a first threshold and an RSRP and/or RSRQ signal of target base station 222-2 is above second threshold. In some implementations, the signaling conditions may be satisfied when a difference between an RSRP and/or RSRQ signal of serving base station 222-1 and an RSRP and/or RSRQ signal of target base station 222-2 is larger than a corresponding threshold (e.g., a threshold number (N) of dB). When the signal condition(s) are not satisfied, process 600 may return to UE 210 calculating, monitoring, and/or determining whether distance 1 satisfies the distance threshold (at 630).

When the signal condition(s) are satisfied, process 600 may proceed by UE 210 reporting to serving base station 222-1 that the RSRP and/or RSRQ condition has been satisfied (at 650).

As shown, process 600 may proceed by serving base station 222-1 responding by base station 222-1 providing TA information to UE 210 and performing a handover procedure (block 660). The TA information may be to enable UE 210 to communicate with target base station 222-2. In some implementations, serving base station 222-1 may provide UE 210 with location information of target base station 222-2, and UE 210 may derive the TA based on a current location of UE 210 and the location information of target base station 222-2.

The handover procedure may include an inter-frequency handover procedure or an intra-frequency handover procedure. Additionally, the handover procedure may include base station 222-1 sending a handover request to target base station 222-2, target base station 222-2 performing admission control, and base station 222-1 receiving a handover request acknowledgement from base station 222-2. The handover procedure may also include serving base station 222-1 sending UE 210 a handover trigger message and detaching from the serving base station 222-1, discovering, synchronizing, and connecting to target base station 222-2, etc. In some implementations, base station 222-1 may provide TA information to UE 210 regarding target base station 222-2. UE 210 may use the TA to transmit a random access channel (RACH) message to target base station 222-2. The RACH Tx timing may be based on a DL reception time (from target base station 222-2) minus the TA. UE 210 may use the TA information to contact and begin communicating with target base station 222-2 as part of the handover procedure. Additional and/or alternative operations (e.g., messages, types of information, etc.) may be involved in performing the handover procedure.

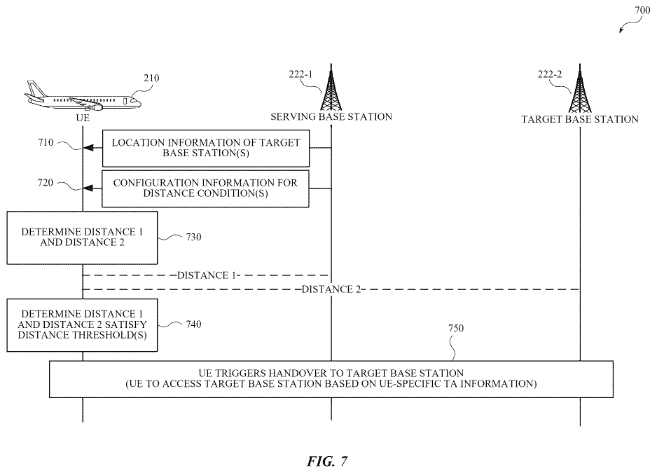

FIG. 7 is a diagram of an example process 700 for UE 210 making a handover decision based on UE distances according to one or more implementations described herein. As shown, process 700 may include serving base station 222-1 providing UE 210 with location information of one or more target base stations 222-2 (at 710). Base station 222-1 may have this information stored locally and/or may obtain it from other base stations 222 as describe above. The location information may be a preconfigured list of base stations 222 or a list of base stations 222 that are identified based on a current position, direction, and speed of UE 210, a travel path of UE 210, and/or one or more factors.

Process 700 may include base station 222-1 providing UE 210 with configuration information about distances and/or conditions related to handover procedures (at 720). The configuration information may define a first distance (distance 1) as a distance between serving base station 222-1 and UE 210. The configuration information may define a second distance (distance 2) as a distance between UE 210 and one or more target base stations 222-2. This may include target base stations 222-2 identified by the location information of potential target base stations provided to UE 210 previously. The configuration information about distances and/or conditions may include a first threshold (threshold 1) for distance 1, a second threshold (threshold 2), and a third threshold (threshold 3) for a difference between distance 1 and distance 2.

Process 700 may include UE 210 determining or calculating distance 1 and distance 2 (at 730). Process 700 may also include UE 210 comparing distances 1 and 2 to thresholds 1 and 2, respectively. When UE 210 determines that distances 1 and 2 do not satisfy thresholds 1 and 2, UE 210 may return to a previous operation, such as serving base station 222-1 providing UE 210 with location information of one or more target base stations 222-2 (at 710). When UE 210 determines that distances 1 and 2 satisfy thresholds 1 and 2, respectively (at 740), process 700 may proceed with UE 210 triggering a handover procedure toward target base station 222-2, where UE 210 may use a UE-specific TA to communicate with target base station 222-2 (at 750). In some implementations, UE 210 may determine the UE-specific TA based on a distance between UE 210 and target base station 222-2. A UE-specific TA may include a round-trip-time (RRT) derived from a propagation delay from target base station 222-2 to UE 210. So, the TA may equal RTT, which may equal two times the propagation delay or two times a distance between target base station 222-2 to UE 210 divided the speed of light. The handover procedure may include an inter-frequency handover procedure or an intra-frequency handover procedure.

Additionally, or alternatively, the handover procedure triggered by UE 210 may include UE 210 detaching from an original serving cell and transmitting a RACH message directly to the target cell. The RACH transmission timing may be based on a DL reception timing of the target cell minus the UE-specific TA. There may be no additional information exchange between base stations 222 after UE 210 satisfies the HO condition.

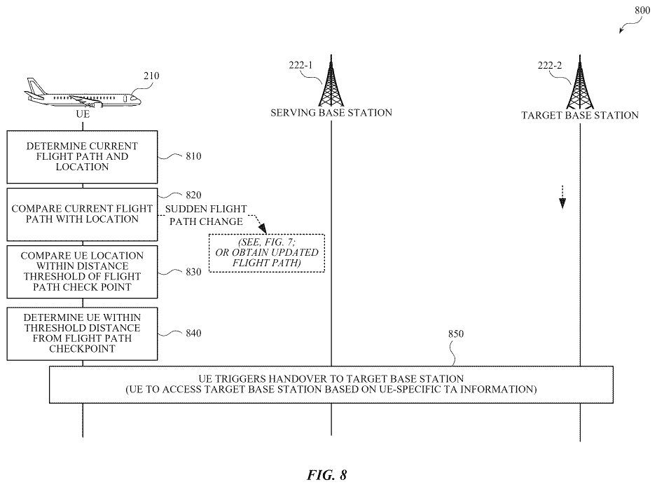

FIG. 8 is a diagram of an example process 800 for a UE making a handover decision based on a UE flight path according to one or more implementations described herein. As shown, process 800 may include UE 210 determining a current flight path and location of UE 210 (at 810). For example, UE 210 may obtain a current flight path by communicating (via base station 222-1) a request to ATC servers 270 for a flight path for UE 210 and receiving a flight path in response thereto. Additionally, or alternatively, UE 210 may obtain a current flight path from a local or internal system (e.g., an on-board computerized system of the airplane, drone, etc.). UE 210 may determine a current location of UE 210 via self-positioning. Self-positioning may include UE 210 determining its location using a global positioning system (GPS), a Global navigation satellite system (GNSS), etc.

Process 800 may include UE 210 comparing a current flight path with a current location of UE 210 (at 820). For example, UE 210 may determine a current location of UE 210 and compare the current location with the flight path to determine whether a sudden change in the flight path has occurred. UE 210 may determine this by comparing a distance from a flight path coordinate to the current location and determining whether the differential exceeds a preconfigured threshold. When a sudden change of flight path has occurred, process 800 may proceed to evaluate and/or perform a handover procedure in accordance with one or more of the operations of FIG. 7. Alternatively, UE 210 may request and receive an updated flight path from, for example, serving base station 222-1 or ATC servers 270 (not shown). The updated flight path may be viewed or used as a current flight path. When a sudden change of flight path has not occurred, process 800 may proceed by UE 210 determining whether a current location of UE 210 is within a threshold distance of a flight path check point.

The flight path may include one or more check points, and each check point may correspond to a handover procedure to be performed when UE 210 is within a threshold distance of the check point. As such, UE 210 may determine a distance between a current location of UE 210 and a check point of the flight path and compare the determined distance to a threshold distance. When the determined distance is greater than the threshold distance, process 800 may proceed by UE 210 continuing to monitor changes in the flight plan and changes in a distance between the UE 210 and the check point (at 820 and 830). When the determined distance is less than the threshold distance (at 840), process 800 may proceed by UE 210 triggering a handover procedure toward target base station 222-2, where UE 210 may use a UE-specific TA to communicate with target base station 222-2 (at 850). In some implementations, UE 210 may determine the UE-specific TA based on a distance between UE 210 and target base station 222-2. The handover procedure may include an inter-frequency handover procedure or an intra-frequency handover procedure. Additionally, or alternatively, the handover procedure triggered by UE 210 may include UE 210 detaching from an original serving cell and transmitting a RACH message directly to the target cell. The RACH transmission timing may be based on a DL reception timing of the target cell minus the UE-specific TA. There may be no additional information exchange between base stations 222 after UE 210 satisfies the HO condition.

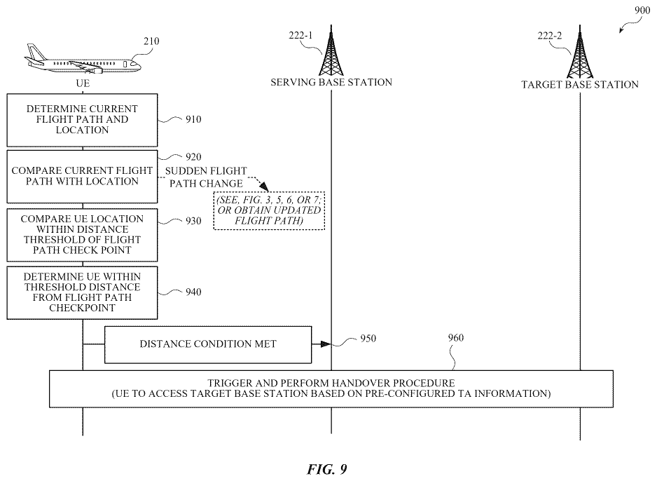

FIG. 9 is a diagram of an example process 900 for serving base station 222-1 making a handover decision based on UE 210 reaching a flight path checkpoint according to one or more implementations described herein. As shown, process 900 may include UE 210 determining a PATENT APPLICATION current flight path and location of UE 210 (at 910). For example, UE 210 may obtain a current flight path by communicating (via base station 222-1) a request to ATC servers 270 for a flight path for UE 210 and receiving a flight path in response thereto. Additionally, or alternatively, UE 210 may obtain a current flight path from a local or internal system (e.g., an on-board computerized system of the airplane, drone, etc.). UE 210 may determine a current location of UE 210 via self-positioning. Self-positioning may include UE 210 determining its location using a global positioning system (GPS), a Global navigation satellite system (GNSS), etc.

Process 900 may include UE 210 comparing a current flight path with a current location of UE 210 (at 920). For example, UE 210 may determine a current location of UE 210 and compare the current location with the flight path to determine whether a sudden change in the flight path has occurred. UE 210 may determine this by comparing a distance from a flight path coordinate to the current location and determining whether the differential exceeds a preconfigured threshold. When a sudden change of flight path has occurred, process 900 may proceed to evaluate and/or perform a handover procedure in accordance with one or more of the operations of FIGS. 3, 5, 6, and/or 7). Alternatively, UE 210 may request and receive an updated flight path from, for example, serving base station 222-1 or ATC servers 270 (not shown). The updated flight path may be viewed or used as a current flight path. When a sudden change of flight path has not occurred, process 900 may proceed by UE 210 determining whether a current location of UE 210 is within a threshold distance of a flight path check point.

The flight path may include one or more check points, and each check point may correspond to a handover procedure to be performed when UE 210 is within a threshold distance of the check point. As such, UE 210 may determine a distance between a current location of UE 210 and a check point of the flight path and compare the determined distance to a threshold distance. When the determined distance is greater than the threshold distance, process 900 may proceed by UE 210 continuing to monitor changes in the flight plan and changes in a distance between the UE 210 and the check point (at 920 and 930). When the determined distance is less than the threshold distance (at 940), process 900 may proceed by UE 210 reporting or communicating to base station 222-1 that distance condition has been met (at 950).

Process 900 may include base station 222-1 responding by base station 222-1 providing triggering a handover procedure (block 960). The handover procedure may include an inter-frequency handover procedure or an intra-frequency handover procedure. Additionally, the handover procedure may include base station 222-1 sending a handover request to target base station 222-2, target base station 222-2 performing admission control, and base station 222-1 receiving a handover request acknowledgement from base station 222-2. The handover procedure may also include serving base station 222-1 sending UE 210 a handover trigger message and detaching from the serving base station 222-1, discovering, synchronizing, and connecting to target base station 222-2, etc. UE 210 may use a TA to communicate (e.g., to transmit a RACH message) with target base station 222-2. The TA may be based on a distance between UE 210 and target base station 222-2. In some implementations, the TA may be a preconfigured TA (e.g., preconfigured by the network) according to each check point along a flight path.

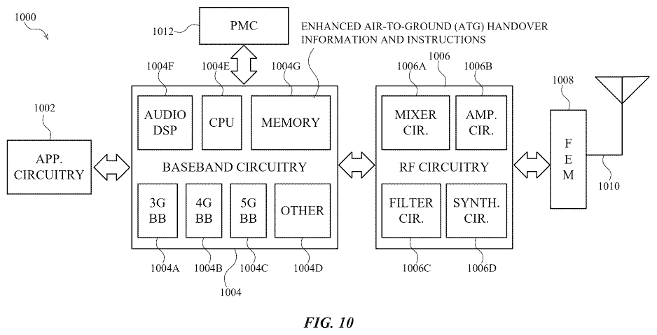

FIG. 10 is a diagram of an example of components of a device according to one or more implementations described herein. In some implementations, the device 1000 can include application circuitry 1002, baseband circuitry 1004, RF circuitry 1006, front-end module (FEM) circuitry 1008, one or more antennas 1010, and power management circuitry (PMC) 1012 coupled together at least as shown. The components of the illustrated device 1000 can be included in a UE or a RAN node. In some implementations, the device 1000 can include fewer elements (e.g., a RAN node may not utilize application circuitry 1002, and instead include a processor/controller to process IP data received from a CN or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuity 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 5G, 6G, etc.). The baseband circuitry 1004 (e.g., one or more of baseband processors 1004A-D) can handle various radio control functions that enable communication with one or more radio networks via the RF circuitry 1006. In other implementations, some or all the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some implementations, modulation/demodulation circuitry of the baseband circuitry 1004 can include Fast-Fourier Transform (FFT), precoding, or constellation mapping/de-mapping functionality. In some implementations, encoding/decoding circuitry of the baseband circuitry 1004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1004G may receive and store one or more configurations, instructions, and/or other types of information for enabling enhanced ATG handover procedures for high-velocity UEs, as described herein with respect to FIGS. 3-9. For example, the enhanced ATG handover procedures may include a UE 210 or serving base station 222 making a handover decision based on distances between UE 210 and serving base stations 222 and target base station 222. In some scenarios, UE 210 or serving base station 222 may make a handover decision based on a UE flight path, including changes in a UE flight path or UE 210 reaching a flight path checkpoint (e.g., a location identified along the flightpath). In some scenarios, serving base station 222 may make a handover decision based on a distance report from UE 210 or UE 110 may make the handover decision based on a signal strength and/or quality from target base station 222. Additional details and examples of these and other implementations are described below with reference to the Figures.

In some implementations, the baseband circuitry 1004 can include one or more audio digital signal processor(s) (DSP) 1004F. The audio DSPs 1004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all the constituent components of the baseband circuitry 1004 and the application circuitry 1002 can be implemented together such as, for example, on a system on a chip (SOC).

In some implementations, the baseband circuitry 1004 can provide for communication compatible with one or more radio technologies. For example, in some implementations, the baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path. In some implementations, the mixer circuitry 1006A of the receive signal path can be configured to down-convert RF signals received from the FEM circuitry 1008 based on the synthesized frequency provided by synthesizer circuitry 1006D. The amplifier circuitry 1006B can be configured to amplify the down-converted signals and the filter circuitry 1006C can be a low-pass filter (LPF) or band-pass filter (BPF) configured to remove unwanted signals from the down-converted signals to generate output baseband signals. Output baseband signals can be provided to the baseband circuitry 1004 for further processing. In some implementations, the output baseband signals can be zero-frequency baseband signals, although this is not a requirement. In some implementations, mixer circuitry 1006A of the receive signal path can comprise passive mixers, although the scope of the implementations is not limited in this respect.

In some implementations, the mixer circuitry 1006A of the transmit signal path can be configured to up-convert input baseband signals based on the synthesized frequency provided by the synthesizer circuitry 1006D to generate RF output signals for the FEM circuitry 1008. The baseband signals can be provided by the baseband circuitry 1004 and can be filtered by filter circuitry 1006C.

In some implementations, the mixer circuitry 1006A of the receive signal path and the mixer circuitry 1006A of the transmit signal path can include two or more mixers and can be arranged for quadrature down conversion and up conversion, respectively. In some implementations, the mixer circuitry 1006A of the receive signal path and the mixer circuitry 1006A of the transmit signal path can include two or more mixers and can be arranged for image rejection (e.g., Hartley image rejection). In some implementations, the mixer circuitry 1006A of the receive signal path and the mixer circuitry 1406A can be arranged for direct down conversion and direct up conversion, respectively. In some implementations, the mixer circuitry 1006A of the receive signal path and the mixer circuitry 1006A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1006 can include analog-to-digital converter (ADC) and digital-to-analog converter (DAC) circuitry and the baseband circuitry 1004 can include a digital baseband interface to communicate with the RF circuitry 1006.

In some dual-mode implementations, a separate radio IC circuitry can be provided for processing signals for each spectrum, although the scope of the implementations is not limited in this respect.

In some implementations, the synthesizer circuitry 1006D can be a fractional-N synthesizer or a fractional N/N+1 synthesizer, although the scope of the implementations is not limited in this respect as other types of frequency synthesizers can be suitable. For example, synthesizer circuitry 1006D can be a delta-sigma synthesizer, a frequency multiplier, or a synthesizer comprising a phase-locked loop with a frequency divider.

The synthesizer circuitry 1006D can be configured to synthesize an output frequency for use by the mixer circuitry 1006A of the RF circuitry 1006 based on a frequency input and a divider control input. In some implementations, the synthesizer circuitry 1006D can be a fractional N/N+1 synthesizer.

In some implementations, frequency input can be provided by a voltage-controlled oscillator (VCO), although that is not a requirement. Divider control input can be provided by either the baseband circuitry 1004 or the applications circuitry 1002 depending on the desired output frequency. In some implementations, a divider control input (e.g., N) can be determined from a look-up table based on a channel indicated by the applications circuitry 1002.

Synthesizer circuitry 1006D of the RF circuitry 1006 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1006 can include an IQ/polar converter.

FEM circuitry 1008 can include a receive signal path which can include circuitry configured to operate on RF signals received from one or more antennas 1010, amplify the received signals and provide the amplified versions of the received signals to the RF circuitry 1006 for further processing. FEM circuitry 1008 can also include a transmit signal path which can include circuitry configured to amplify signals for transmission provided by the RF circuitry 1006 for transmission by one or more of the one or more antennas 1010. In various implementations, the amplification through the transmit or receive signal paths can be done solely in the RF circuitry 1006, solely in the FEM circuitry 1008, or in both the RF circuitry 1006 and the FEM circuitry 1008.

In some implementations, the FEM circuitry 1008 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1006). The transmit signal path of the FEM circuitry 1008 can include a power amplifier (PA) to amplify input RF signals (e.g., provided by RF circuitry 1006), and one or more filters to generate RF signals for subsequent transmission (e.g., by one or more of the one or more antennas 1010).

In some implementations, the PMC 1012 can manage power provided to the baseband circuitry 1004. In particular, the PMC 1012 can control power-source selection, voltage scaling, battery charging, or DC-to-DC conversion. The PMC 1012 can often be included when the device 1000 is capable of being powered by a battery, for example, when the device is included in a UE. The PMC 1012 can increase the power conversion efficiency while providing desirable implementation size and heat dissipation characteristics.

While FIG. 10 shows the PMC 1012 coupled only with the baseband circuitry 1004. However, in other implementations, the PMC 1012 may be additionally or alternatively coupled with, and perform similar power management operations for, other components such as, but not limited to, application circuitry 1002, RF circuitry 1006, or FEM circuitry 1008.

In some implementations, the PMC 1012 can control, or otherwise be part of, various power saving mechanisms of the device 1000. For example, if the device 1000 is in an RRC_Connected state, where it is still connected to the RAN node as it expects to receive traffic shortly, then it can enter a state known as discontinuous reception mode (DRX) after a period of inactivity. During this state, the device 1000 can power down for brief intervals of time and thus save power.

If there is no data traffic activity for an extended period of time, then the device 1000 can transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1002 and processors of the baseband circuitry 1004 can be used to execute elements of one or more instances of a protocol stack. For example, processors of the baseband circuitry 1004, alone or in combination, can be used execute Layer 3, Layer 2, or Layer 1 functionality, while processors of the baseband circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

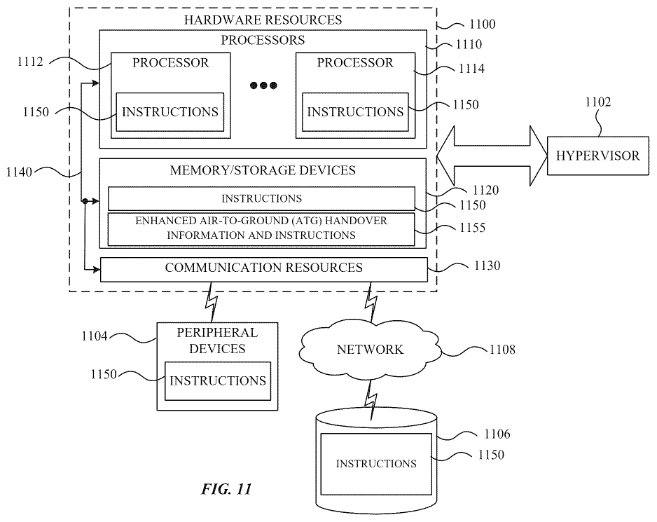

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140. For implementations where node virtualization (e.g., NFV) is utilized, a hypervisor may be executed to provide an execution environment for one or more network slices/sub-slices to utilize the hardware resources 1100 The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1112 and a processor 1114.

The memory/storage devices 1120 may include main memory, disk storage, or any suitable combination thereof. The memory/storage devices 1120 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1120 may receive and store one or more configurations, instructions, and/or other type of information 1155 for enabling ATG handover procedures for high-velocity UEs. For example, UE 210 or serving base station 222 may make a handover decision based on distances between UE 210 and serving base stations 222 and target base station 222. In some scenarios, UE 210 or serving base station 222 may make a handover decision based on a UE flight path, including changes in a UE flight path or UE 210 reaching a flight path checkpoint (e.g., a location identified along the flightpath). In some scenarios, serving base station 222 may make a handover decision based on a distance report from UE 210 or UE 110 may make the handover decision based on a signal strength and/or quality from target base station 222. Additional details and examples of these and other implementations are described below with reference to the Figures.

The communication resources 1130 may include interconnection or network interface components or other suitable devices to communicate with one or more peripheral devices 1104 or one or more databases 1106 via a network 1108. For example, the communication resources 1130 may include wired communication components (e.g., for coupling via a universal serial bus (USB)), cellular communication components, NFC components, Bluetooth® components (e.g., Bluetooth® low energy), Wi-Fi@ components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user equipment (UE) may comprise: a memory; and one or more processors configured to, when executing instructions stored in the memory, cause the UE to: receive, from a serving base station, a distance threshold corresponding to the serving base station; receive, from the serving base station, a location information and signal condition of a target base station; determine that a distance, between the UE and the serving base station, satisfies the distance threshold; determine that signaling, from the target base station, satisfies the signal condition; and report, to the serving base station, that the signaling condition is satisfied to trigger a handover procedure.

In example 2, which may also include one or more of the examples described herein, the signal condition comprises a reference signal received power (RSRP) threshold. In example 3, which may also include one or more of the examples described herein, the signal condition comprises a reference signal received quality (RSRQ) threshold. In example 4, which may also include one or more of the examples described herein, the signal condition comprises an RSRP/RSRQ threshold.

In example 5, which may also include one or more of the examples described herein, the signal condition comprises when an RSRP/RSRQ of the serving base station being below a first signal threshold and an RSRP/RSRQ of the target base station is above a second signal threshold. In example 6, which may also include one or more of the examples described herein, the signal condition comprises a difference between an RSRP/RSRQ of the serving base station and an RSRP/RSRQ of the target base station being greater than a threshold difference. In example 7, which may also include one or more of the examples described herein, the UE is to determine that the signaling satisfies the signal condition upon determining that the distance satisfies the distance threshold.

In example 8, which may also include one or more of the examples described herein, the UE is to receive, from the serving base station, a timing advance (TA) value for communicating with the target base station. In example 9, which may also include one or more of the examples described herein, the UE is to participate in the handover procedure by communicating with the target base station based on the TA value. In example 10, which may also include one or more of the examples described herein, the UE is to: receive, from the serving base station, location information of the target base station; derive, based on a location of the UE and the target base station, a timing advance (TA) value for communicating with the target base station; and participate in the handover procedure by communicating with the target base station based on the TA value.

In example 11, which may also include one or more of the examples described herein, a user equipment (UE) may comprise: a memory; and one or more processors configured to, when executing instructions stored in the memory, cause the UE to: receive, from a serving base station, location information of a target base station; receive, from the serving base station, configuration information for one or more distance conditions, determine a first distance from the UE to the serving base station; determine, based on the location information, a second distance from the UE to the target base station; and when the first distance and the second distance satisfy the one or more distance conditions, trigger a handover procedure toward the target base station.

In example 12, which may also include one or more of the examples described herein, the one or more distance conditions comprise a first distance threshold and a second distance threshold that is different from the first distance threshold. In example 13, which may also include one or more of the examples described herein, the first distance threshold corresponds to the serving base station and the second distance threshold corresponds to the target base station. In example 14, which may also include one or more of the examples described herein, the one or more distance conditions comprises a difference between the first distance and the second distance. In example 15, which may also include one or more of the examples described herein, the UE is to trigger the handover procedure when the difference between the first distance and the second distance satisfies a third distance threshold.

In example 16, which may also include one or more of the examples described herein, the UE is to participate in the handover procedure based on a timing advance (TA) value for communicating with the target base station. In example 17, which may also include one or more of the examples described herein, the UE is to derive the TA value based on a distance between the UE and the target base station. In example 18, which may also include one or more of the examples described herein, a method, performed, by a user equipment (UE), may comprise: receiving, from a serving base station, a distance threshold corresponding to the serving base station; receiving, from the serving base station, a location information and signal condition of a target base station; determining that a distance, between the UE and the serving base station, satisfies the distance threshold; determining that signaling, from the target base station, satisfies the signal condition; and reporting, to the serving base station, that the signaling condition is satisfied to trigger a handover procedure.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should be construed to mean “one or more” unless specified otherwise or clear from context to be directed to a singular form. Furthermore, to the extent that the terms “including,” “includes,” “having,” “has,” “with,” or variants thereof are used in either the detailed description or the claims, such terms are intended to be inclusive in a manner similar to the term “comprising.” Additionally, in situations wherein one or more numbered items are discussed (e.g., a “first X,” a “second X,” etc.), in general the one or more numbered items can be distinct, or they can be the same, although in some situations the context may indicate that they are distinct or that they are the same.

It is well understood that the use of personally identifiable information should follow privacy policies and practices that are recognized as meeting or exceeding industry or governmental requirements for maintaining the privacy of users.

Personally identifiable information data should be managed and handled to minimize risks of unintentional or unauthorized access or use, and the nature of authorized use should be clearly indicated to users.

1. A user equipment (UE), comprising:
a memory; and
one or more processors configured to, when executing instructions stored in the memory, cause the UE to:
receive, from a serving base station, a distance threshold corresponding to the serving base station;
receive, from the serving base station, a signal condition of a target base station;
determine that a distance, between the UE and the serving base station, satisfies the distance threshold;
determine that signaling, from the target base station, satisfies the signal condition; and
report, to the serving base station, that the signaling condition is satisfied to trigger a handover procedure.

2. The UE of claim 1, wherein the signal condition comprises a reference signal received power (RSRP) threshold.

3. The UE of claim 1, wherein the signal condition comprises a reference signal received quality (RSRQ) threshold.

4. The UE of claim 1, wherein the signal condition comprises an RSRP/RSRQ threshold.

5. The UE of claim 1, wherein the signal condition comprises when an RSRP/RSRQ of the serving base station being below a first signal threshold and an RSRP/RSRQ of the target base station is above a second signal threshold.

6. The UE of claim 1, wherein the signal condition comprises a difference between an RSRP/RSRQ of the serving base station and an RSRP/RSRQ of the target base station being greater than a threshold difference.

7. The UE of claim 1, wherein the UE is to determine that the signaling satisfies the signal condition upon determining that the distance satisfies the distance threshold.

8. The UE of claim 1, wherein the UE is to receive, from the serving base station, a timing advance (TA) value for communicating with the target base station.

9. The UE of claim 8, wherein the UE is to participate in the handover procedure by communicating with the target base station based on the TA value.

10. The UE of claim 1, wherein the UE is to:
receive, from the serving base station, location information of the target base station;
derive, based on a location of the UE and the target base station, a timing advance (TA) value for communicating with the target base station; and
participate in the handover procedure by communicating with the target base station based on the TA value.

11. A user equipment (UE), comprising:
a memory; and
one or more processors configured to, when executing instructions stored in the memory, cause the UE to:
receive, from a serving base station, location information of a target base station;
receive, from the serving base station, configuration information for one or more distance conditions,
determine a first distance from the UE to the serving base station;
determine, based on the location information, a second distance from the UE to the target base station; and
when the first distance and the second distance satisfy the one or more distance conditions, trigger a handover procedure toward the target base station.

12. The UE of claim 11, wherein the one or more distance conditions comprise a first distance threshold and a second distance threshold that is different from the first distance threshold.

13. The UE of claim 12, wherein the first distance threshold corresponds to the serving base station and the second distance threshold corresponds to the target base station.

14. The UE of claim 12, wherein the one or more distance conditions comprises a difference between the first distance and the second distance.

15. The UE of claim 14, wherein the UE is to trigger the handover procedure when the difference between the first distance and the second distance satisfies a third distance threshold.

16. The UE of claim 11 wherein the UE is to participate in the handover procedure based on a timing advance (TA) value for communicating with the target base station.

17. The UE of claim 16, wherein the UE is to derive the TA value based on a distance between the UE and the target base station.

18. A method, performed, by a user equipment (UE), the method comprising:
receiving, from a serving base station, a distance threshold corresponding to the serving base station;
receiving, from the serving base station, a location information and signal condition of a target base station;
determining that a distance, between the UE and the serving base station, satisfies the distance threshold;
determining that signaling, from the target base station, satisfies the signal condition; and
reporting, to the serving base station, that the signaling condition and the distance threshold are satisfied to trigger a handover procedure.

19. The method of claim 18, wherein the signal condition comprises a reference signal received power (RSRP) threshold.

20. The method of claim 18, wherein the signal condition comprises a reference signal received quality (RSRQ) threshold.
